(19) United States
(12) Patent Application Publication
(10) Pub. No.: US 2015/0010397 A1
(43) Pub. Date: Jan. 8, 2015

(54) EXHAUST TURBOCHARGER

(71) Applicant: BorgWarner Inc., Auburn Hills, MI (US)

(72) Inventor: Timo Scheuermann, Mainz (DE)

(21) Appl. No.: 14/371,876

(22) PCT Filed: Jan. 8, 2013
(86) PCT No.: PCT/US2013/020639

§ 371 Date: Jul. 11, 2014

(30) Foreign Application Priority Data
Jan. 17, 2012 (DE) 102012000802.3

(51) Int. Cl. F01D 25/28; F02B 47/08

(52) U.S. Cl. CPC F01D 25/28; F02B 47/08
USPC 415/213.1

(57) ABSTRACT

An exhaust turbocharger (1) having a turbine housing (2), which has an inlet stub (3), and having a connecting device (4) for securing the inlet stub (3) on an exhaust-gas supply device (5). The connecting device (4) is designed as a plug-in connecting device.

The invention relates to an exhaust turbocharger in accordance with the preamble of claim 1.

In the case of known exhaust turbochargers, the inlet stub of the turbine housing is, for example, secured on a cylinder head or an exhaust manifold of an internal combustion engine by means of a screwed joint, with a seal in between. However, such fastenings are relatively expensive both to produce and to assemble.

It is therefore the object of the present invention to provide an exhaust turbo-charger of the type stated in the preamble of claim 1, the turbine housing of which has a simplified connecting device for connection to an exhaust-gas supply device, such as a cylinder head or an exhaust manifold.

This object is achieved by the features of claim 1.

Providing a connecting device designed as a plug-in connecting device gives a certain degree of freedom in the joint, ensuring that no problems occur, even when there are slight deviations in the assembly angle.

In particular, there are no sealing problems since the degree of freedom inherent in the design makes it possible to compensate especially for angular deviations from the precise assembly position.

The dependent claims contain advantageous developments of the invention.

As well as connecting the turbine housing to an exhaust manifold or a cylinder head of an internal combustion engine, the connecting device according to the invention can also be used in connecting a turbocharger of a low-pressure stage to the turbo-charger of a high-pressure stage in the case of two-stage charging.

Providing sealing devices at the ends of the plug-in connecting device, which preferably has a tube section, makes it possible to create different sealing geometries with corresponding degrees of freedom, thus making it possible to ensure that continuous contact between the sealing surfaces, especially in the abovementioned case of slight deviations from the precise assembly angle, is possible.

Further details, advantages and features of the present invention will emerge from the following description of illustrative embodiments with reference to the drawing, in which:

FIG. 1 shows a schematic, slightly simplified representation of a first embodiment of an exhaust turbocharger according to the invention,

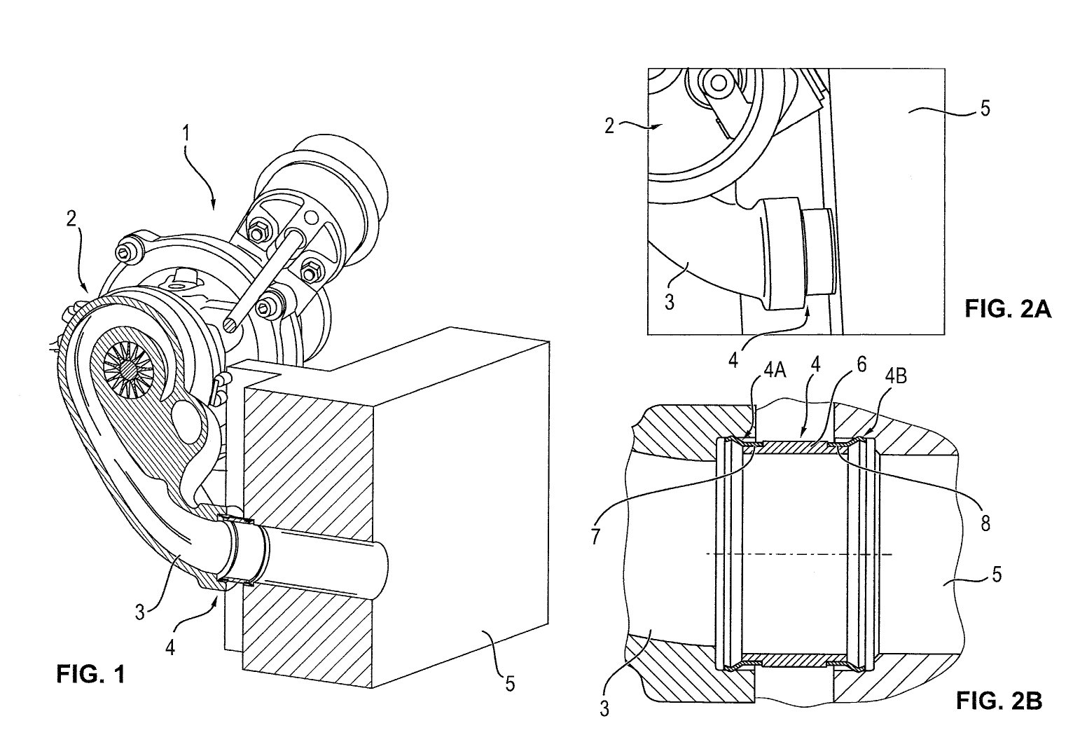

FIGS. 2A, 2B show detail views of the connecting device for the exhaust turbocharger shown in FIG. 1,

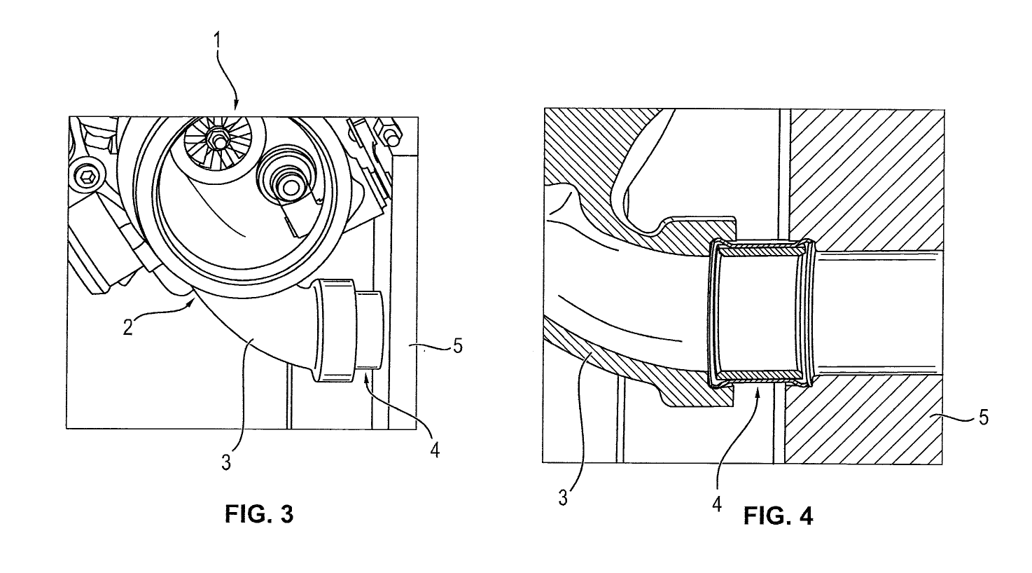

FIG. 3 shows a view corresponding to FIG. 2 of a second embodiment of the exhaust turbocharger according to the invention,

FIG. 4 shows a detail of the connecting device for the exhaust turbo-charger shown in FIG. 3,

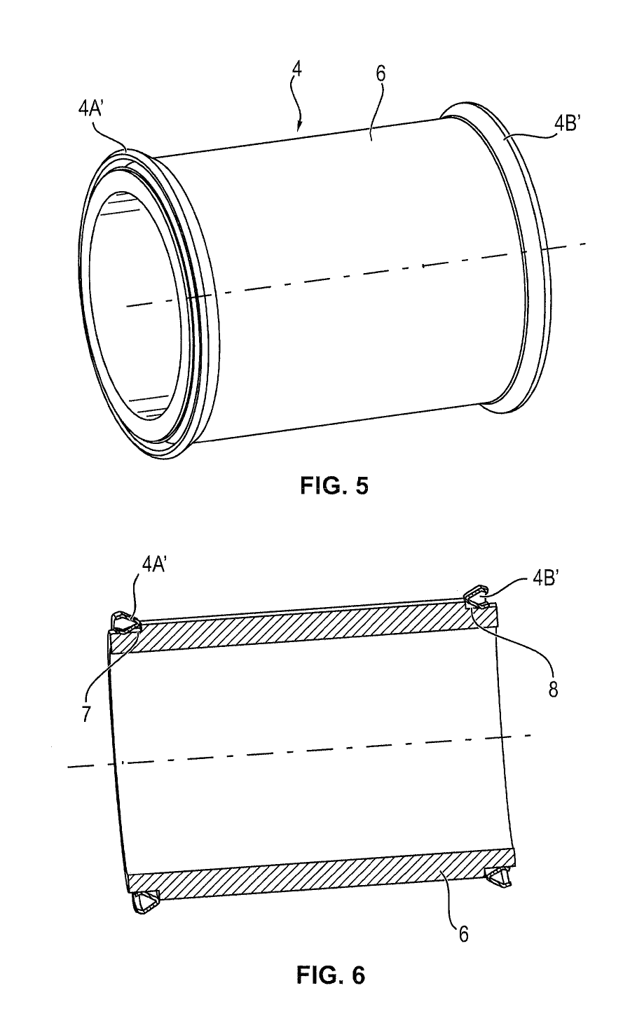

FIGS. 5, 6 show views of a first embodiment of a connecting device according to the invention,

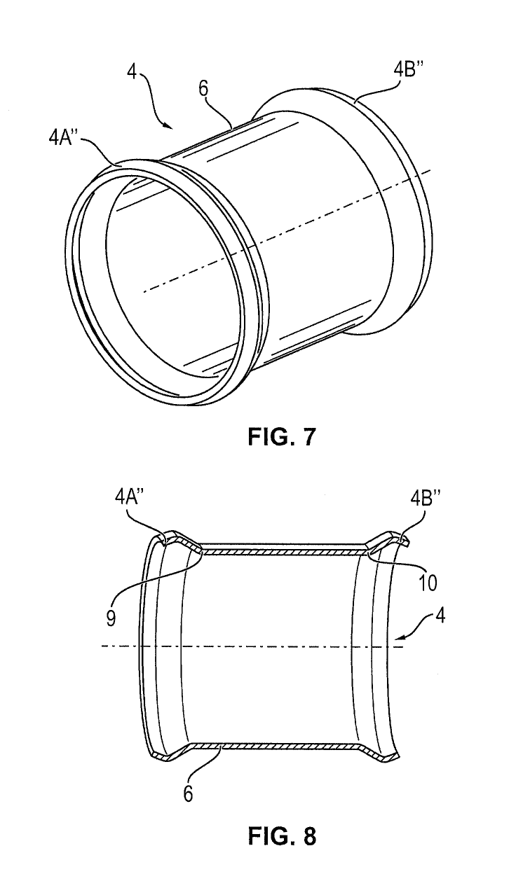

FIGS. 7, 8 show views corresponding to FIGS. 5 and 6 of a second embodiment of the plug-in connecting device according to the invention,

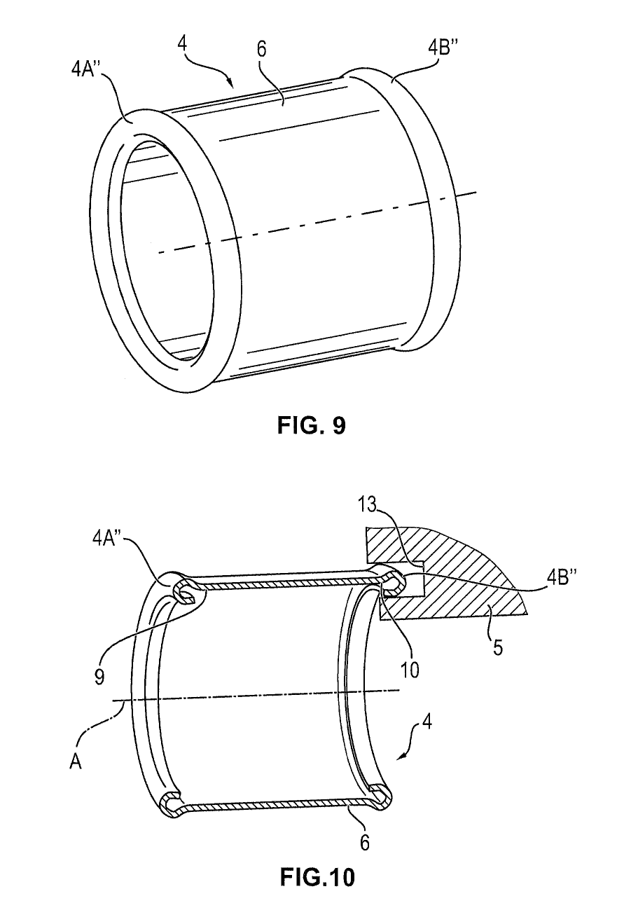

FIGS. 9, 10 show views corresponding to FIGS. 5 and 6 of a third embodiment of the plug-in device according to the invention,

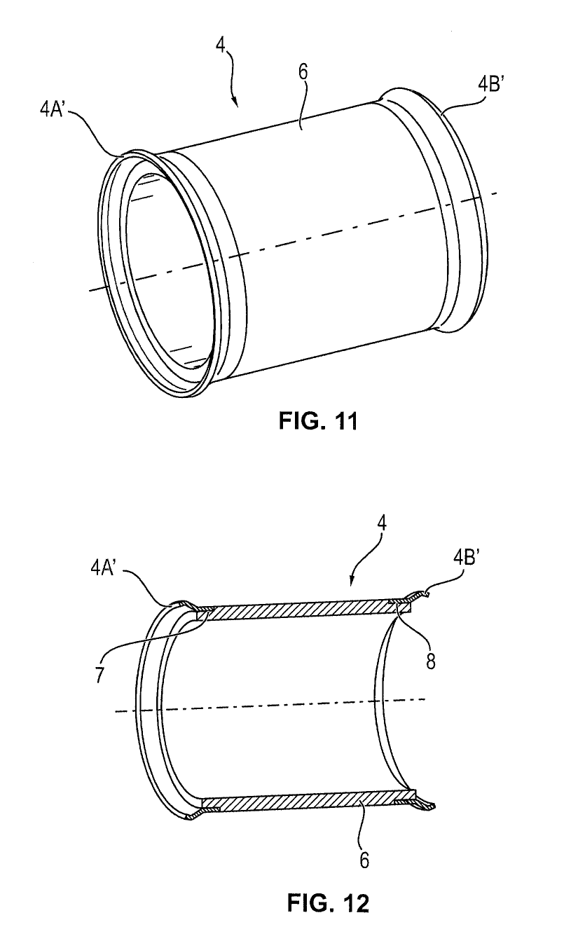

FIGS. 11, 12 show views corresponding to FIGS. 5 and 6 of a fourth embodiment, and

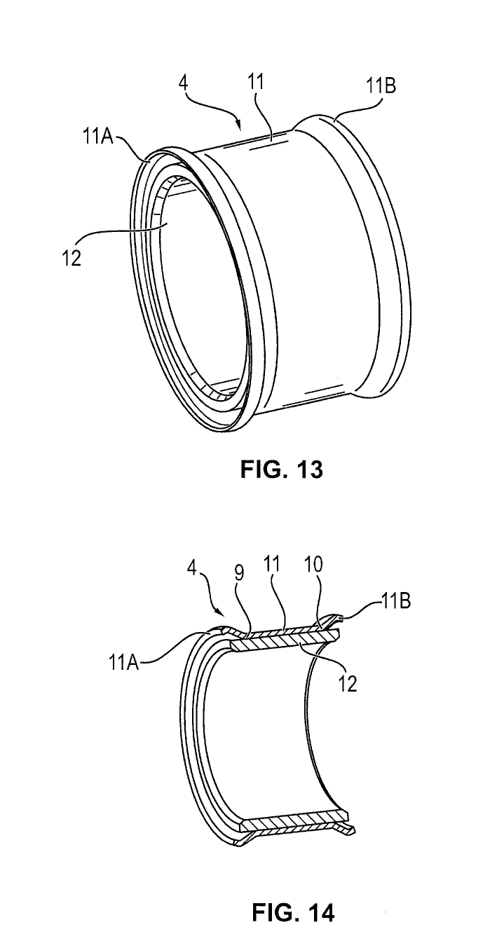

FIGS. 13, 14 show views corresponding to FIGS. 5 and 6 of a fifth embodiment of the plug-in connecting device according to the invention.

FIG. 1 shows a first embodiment of an exhaust turbocharger 1 according to the invention, which has a turbine housing 2 provided with an inlet stub 3 for exhaust gas. By means of the inlet stub 3, the turbine housing 2 can be secured on an exhaust-gas supply device, which is symbolized in FIG. 1 by block 5. As explained at the outset, the exhaust-gas supply device 5 can be an exhaust manifold or a cylinder head of an internal combustion engine, for example.

Of course, the exhaust turbocharger 1 also has all the other components of conventional exhaust turbochargers, such as, in particular, the turbine wheel arranged in the turbine housing 2, a compressor housing with a compressor impeller and a bearing housing, and, if appropriate, a variable turbine geometry including the associated actuating device, but these are not described in detail below since it is not necessary to describe them in order to explain the principles according to the invention.

In order to be able to secure the inlet stub 3 on the exhaust-gas supply device 5, a connecting device 4 is provided which, as can be seen, in particular, from the illustration in FIG. 2B, is a plug-in connecting device. Here, the plug-in connecting device 4 has a tube section 6, which is provided at both ends with grooves 7 and 8, in which respective sealing devices 4A and 4B are arranged. The construction of the plug-in connecting device 4 will be explained in detail below with reference to FIGS. 5 to 14.

FIGS. 3 and 4 show a second embodiment of an exhaust turbocharger 1 according to the invention and of another embodiment of the plug-in connecting device 4 according to the invention, which will likewise be explained in detail with reference to the following Figures.

FIG. 5 shows a perspective view of a first embodiment of the plug-in connecting device 4 according to the invention. The plug-in connecting device 4 has the tube section 6 already mentioned with reference to FIG. 2B, which, in the example, is provided at each end with respective separate sealing rings 4A′ and 4B′, which are placed in the associated encircling grooves 7 and 8. This arrangement can be seen especially from the sectional view in FIG. 6. In the assembled state, which is shown in FIG. 2B and FIG. 4, a connection is created between the inlet stub 3 and the exhaust-gas supply device 5 by means of the plug-in connecting device 4, with the sealing devices 4A, 4B or 4A′ and 4B′ supplying the required sealing effect since they are slightly compressed during the assembly of the plug-in connection, thus ensuring that the required sealing effect for avoiding leakages of exhaust gas can always be maintained, even when there are slight deviations from the precise assembly angle.

FIGS. 7 and 8 show another embodiment of the plug-in connecting device 4, which once again comprises a tube section 6, at the ends 9 and 10 of which in this case integrally formed sealing devices or sealing rings 4A″ and 4B″ are arranged. Accordingly, the plug-in connecting device 4 of embodiment 7 and 8 consists uniformly of the same material, in particular sheet metal, whereas it is possible to produce the tube section 6 and the sealing devices or sealing rings 4A′ and 4B′ from different materials in the embodiment shown in FIGS. 5 and 6.

The embodiment shown in FIGS. 9 and 10 corresponds substantially to that in FIGS. 7 and 8. However, as the sectional view in FIG. 10, in particular, illustrates, the sealing devices or sealing rings 4A″ and 4B″ extend beyond the two end regions 9 and 10, when viewed in the axial direction A of the tube section 6, thus making it easier to insert the sealing rings 4K, 4W into a groove 13 in the exhaust-gas supply device 5. It is possible here to make both sealing rings 4K and 4W project in the axial direction or, alternatively, to make just one of the two sealing rings 4K and 4W in this way.

The embodiment shown in FIGS. 11 and 12 corresponds substantially to that in FIGS. 5 and 6 but, in this case, the sealing devices or sealing rings 4A′ and 4B′ are welded into the associated encircling grooves 7 and 8. As with the embodiment shown in FIGS. 5 and 6, this opens up the possibility of choosing different materials for the tube section 6 and the sealing rings 4A′ and 4B′.

The embodiment shown in FIGS. 13 and 14 has a plug-in connecting device 4, which comprises an outer tube 11, on which sealing devices or sealing rings 11A and 11B are formed integrally in the example. Arranged within the outer tube 11 is an inner tube 12, which assumes the task of carrying the exhaust gas and which can be connected to the outer tube 12, e.g. by means of a weld or by other suitable connection methods. This embodiment too gives more degrees of freedom for the use of different materials for the inner tube 12 and the outer tube 11 with the sealing rings 11A and 11B thereof.

In each of the illustrative embodiments explained above, the advantage is obtained of a simpler construction for the connecting device, greater flexibility as regards the choice of material and simplification of assembly while nevertheless achieving a good sealing effect. This is the case, in particular, even when there are deviations from the precise assembly angle between the inlet stub and the exhaust-gas supply device.

In addition to the above written disclosure of the invention, the graphical representation in FIGS. 1 to 14 is hereby explicitly incorporated by reference to supplement the disclosure.

### LIST OF REFERENCE SIGNS

1 exhaust turbocharger

2 turbine housing

3 inlet stub

4 plug-in connecting device

4A, 4B, 4A′,

4B′, 4A″, 4B″,

11A, 11B sealing devices or sealing rings

5 exhaust-gas supply device

6 tube section

7, 8 grooves

9, 10 ends of the tube section

11 outer tube

11A, 11B sealing devices/sealing rings

12 inner tube

13 groove

1. An exhaust turbocharger (1) with
a turbine housing (2), which has an inlet stub (3), and
a connecting device (4) for securing the inlet stub (3) on an exhaust-gas supply device (5), wherein
the connecting device (4) is a plug-in connecting device.

2. The exhaust turbocharger as claimed in claim 1, wherein the plug-in connecting device (4) has a tube section (6; 11) which is provided at each of its ends with a sealing device (4A, 4B; 4A′, 4B′; 4A″, 4B″; 11A, 11B).

3. The exhaust turbocharger as claimed in claim 2, wherein each sealing device is designed as a separate sealing ring (4A′, 4B′) which is inserted into an associated encircling groove (7, 8) in the tube section (6).

4. The exhaust turbocharger as claimed in claim 2, wherein the sealing device is in each case designed as a sealing ring (4A″, 4B″; 11A, 11B) connected integrally to the tube section (6; 11).

5. The exhaust turbocharger as claimed in claim 4, wherein the integral sealing ring (4A″, 4B″) is designed as a ring which projects beyond the ends (9, 10) of the tube section (6), when viewed in the axial direction (A) of the tube section (6).

6. The exhaust turbocharger as claimed in claim 3, wherein the sealing rings (4A′, 4B′) are welded into the respective groove (7, 8).

7. The exhaust turbocharger as claimed in claim 6, wherein the materials of the sealing rings (4A′, 4B′) and of the tube section (6) are different.

8. The exhaust turbocharger as claimed in claim 5, wherein the connecting device (4) has an outer tube (11) with integrated end sealing rings (11A, 11B) and an inner tube (12), which is arranged in the outer tube (11).

9. The exhaust turbocharger as claimed in claim 8, wherein the outer tube (11) and the inner tube (12) are connected to one another.

10. The exhaust turbocharger as claimed in claim 8, wherein the materials of the outer tube (11) and of the inner tube (12) are different.

11. A connecting device (4) for a turbine housing (2) of an exhaust turbocharger (1), in which the turbine housing (2) has an inlet stub (3), wherein the connecting device (4) is designed as a plug-in connecting device.

12. The connecting device as claimed in claim 11, wherein the plug-in connecting device (4) has a tube section (6; 11) which is provided at each of its ends with a sealing device (4A, 4B; 4A′, 4B′; 4A″, 4B″; 11A, 11B).

13. The exhaust turbocharger as claimed in claim 8, wherein the outer tube (11) and the inner tube (12) are welded to one another.

14. The exhaust turbocharger as claimed in claim 13, wherein each sealing device is designed as a separate sealing ring (4A′, 4B′) which is inserted into an associated encircling groove (7, 8) in the tube section (6).

15. The exhaust turbocharger as claimed in claim 13, wherein the sealing device is in each case designed as a sealing ring (4A″, 4B″; 11A, 11B) connected integrally to the tube section (6; 11).

16. The exhaust turbocharger as claimed in claim 15, wherein the integral sealing ring (4A″, 4B″) is designed as a ring which projects beyond the ends (9, 10) of the tube section (6), when viewed in the axial direction (A) of the tube section (6).

17. The exhaust turbocharger as claimed in claim 14, wherein the sealing rings (4A′, 4B′) are welded into the respective groove (7, 8).
